(19) United States
(12) Patent Application Publication
(10) Pub. No.: US 2017/0290362 A1
(43) Pub. Date: Oct. 12, 2017

(54) METHOD FOR COOKING HOT PEPPER GIMBAP AND HOT PEPPER GIMBAP COOKING THEREOF

(71) Applicant: Seok-Hyo CHOI, Jinju-si, Gyeongsangnam-do (KR)

(72) Inventor: Seok-Hyo CHOI, Jinju-si, Gyeongsangnam-do (KR)

(21) Appl. No.: 15/511,965

(22) PCT Filed: Sep. 18, 2015
(86) PCT No.: PCT/KR2015/009818

§ 371 Date: Mar. 16, 2017

(30) Foreign Application Priority Data
Sep. 26, 2014 (KR) 10-2014-0129157

(51) Int. Cl. A23L 27/14; A23L 7/196; A23L 17/60; A23L 5/10

(52) U.S. Cl. CPC A23L 27/14; A23L 5/10; A23L 7/1965; A23L 17/60; A23V 2002/00

(57) ABSTRACT

The present invention relates to a method for cooking hot pepper gimbap and hot pepper gimbap cooking thereof, characterized by comprising: hot pepper fillings making process for adding black pepper and cooking oil to hot pepper fillings, including green Cheongyang chili pepper(green Ttaeong Cho), red Cheongyang chili pepper(red Ttaeong Cho), and carrot, and frying; seasoning mixing process for mixing hot pepper fillings and powder seasoning, including condiments and powder seasoning, together and frying again; cooling process for cooling hot pepper fillings with the powder seasoning at room temperature; mixing process for sprinkling black sesame over the rice and mixing the cooled hot pepper fillings with it; and hot pepper gimbap making process for spreading the mixed rice on the dried seaweed sheet and rolling it.

### TECHNICAL FIELD

The present invention relates to a method for cooking hot pepper gimbap and hot pepper gimbap cooking thereof, and more particularly, to a method for cooking hot pepper gimbap and hot pepper gimbap cooking thereof for making gimbap fillings with hot pepper and powder of natural ingredients and then making gimbap by mixing rice and fillings and rolling them with a dried seaweed sheet, thereby satisfying taster's request due to natural spicy taste, not artificial, enabling taster's smooth metabolism, and reducing stress.

### BACKGROUND ART

Generally, people of all ages enjoy gimbap, because it is quite convenient to eat various ingredients with rice simultaneously with taste of original dried seaweed sheets. Especially, gimbap is widely used for a meal in case of a snack for kids or picnic like outdoor activity.

As for general gimbap, rice is evenly spread on a dried seaweed sheet; fillings including vegetables such as carrot, pickled radish, spinach, etc. and meat like sausage etc. are arranged in horizontal rows; these are rolled with a bamboo mat using pressure, thereby making cylinder shaped gimbap; and it is sliced into bite-size pieces.

With such general gimbap, various types of gimbap with all sorts of fillings have been made, wherein there are various tastes with kimchi, tuna, cheese, etc., and various types like Samgak gimbap, in which triangle shaped rice is wrapped up with a dried seaweed sheet, Ggoma gimbap, which is a child-size gimbap, Nude gimbap, in which fillings are rolled with a dried seaweed sheet and rice is shown outside, Chungmu gimbap, a type of gimbap made with only rice and a dried seaweed sheet, serving with side dishes, etc.

Meanwhile, in modern society, people have a strong tendency to look for spicy food. Physiologically, spicy taste belongs to cutaneous sensation which combines sense of pain and temperature sense. An ingredient called spice makes a spicy taste. Various kinds of compounds are included in spicy food and classified into \textcircled{1}odorless component: capsaicin(in pepper), Chinese pepper, black pepper, \textcircled{2}pungent component: Allisothiocyanate(oil: mustard, wasabi), aryl sulfide(green onion), \textcircled{3}aroma component: cinnamyl aldehyde, ginger, eugenol(allspice) in accordance with degree or smell of spicy flavor. Spicy flavor is effective in helping digestion simultaneously with stimulating appetite by adjusting food's flavor. Thus, spices containing spicy taste, appropriate to food ingredients, are used in all cooking.

However, since seasoning or sauce for making spicy taste is used in such general gimbap, thereby making artificial spicy taste, there was a problem that tasters' requests were not satisfied.

### PRIOR ART

### Patent document

Patent document 1: Korean Patent no. 10-1332098

Patent document 2: Korean Patent no. 10-1354999

Patent document 3: Korean Patent no. 10-0874244

### DETAILED EXPLANATIONS OF THE INVENTION

### Technical Problem

For solving above problems, the object of the present invention is to provide a method for cooking hot pepper gimbap and hot pepper gimbap cooking thereof for making gimbap fillings with hot pepper and powder of natural ingredients and then making gimbap by mixing rice and fillings and rolling them with a dried seaweed sheet, thereby satisfying taster's request due to natural spicy taste, not artificial, enabling taster's smooth metabolism, and reducing stress.

### Technical Solution

To accomplish above objects, the present invention is characterized by comprising: hot pepper fillings making process for adding black pepper and cooking oil to hot pepper fillings, including green Cheongyang chili pepper(green Ttaeong Cho), red Cheongyang chili pepper(red Ttaeong Cho), and carrot, and frying; seasoning mixing process for mixing hot pepper fillings and powder seasoning, including condiments and powder seasoning, together and frying again; cooling process for cooling hot pepper fillings with the powder seasoning at room temperature; mixing process for sprinkling black sesame over the rice and mixing the cooled hot pepper fillings with it; and hot pepper gimbap making process for spreading the mixed rice on the dried seaweed sheet and rolling it.

Here, the hot pepper fillings have an intensity of 4,000˜10,000 Scoville heat units and they comprise 20˜40 weight percent of green Cheongyang chili pepper with intensity of 4,000-10,000 Scoville heat units, cut into 1˜5 mm wide and long, 20˜40 weight percent of red Cheongyang chili pepper, cut into 1˜5 mm wide and long, and 20˜40 weight percent of carrot, cut into 1˜5 mm wide and long.

Here, the powder seasoning comprises 20˜40 parts by weight of condiment, 1˜20 parts by weight of kelp dried powder, 1˜20 parts by weight of spinach dried powder and 1˜20 parts by weight of shiitake mushroom dried powder for 100 parts of weight of hot pepper fillings.

Here, in the mixing process, the weight of one gimbap roll is 100˜400 g while comprising 60˜90 weight percent of rice and 10˜40 weight percent of hot pepper fillings.

Further, the present invention is characterized by hot pepper gimbap cooking thereof.

### Advantageous Effects

According to the method for cooking hot pepper gimbap and hot pepper gimbap cooking thereof the present invention, as constituted above, it enables to make gimbap fillings with hot pepper and powder of natural ingredients and then to make gimbap by mixing rice and fillings and rolling them with a dried seaweed sheet, thereby satisfying taster's request due to natural spicy taste, not artificial, enabling taster's smooth metabolism, and reducing stress.

### DESCRIPTION OF DRAWINGS

FIG. 1 is a process explanation diagram for explaining a method for cooking hot pepper gimbap of the present invention.

### DESCRIPTION OF THE PREFERRED EMBODIMENTS

The configuration of a method for cooking hot pepper gimbap, according to the present invention, will be described in detail with the accompanying drawing.

In the following description of the present invention, a detailed description of known incorporated functions and configurations will be omitted when to include them would make the subject matter of the present invention rather unclear. Also, the terms used in the following description are defined taking into consideration the functions provided in the present invention. The definitions of these terms should be determined based on the whole content of this specification, because they may be changed in accordance with the option of a user or operator or a usual practice.

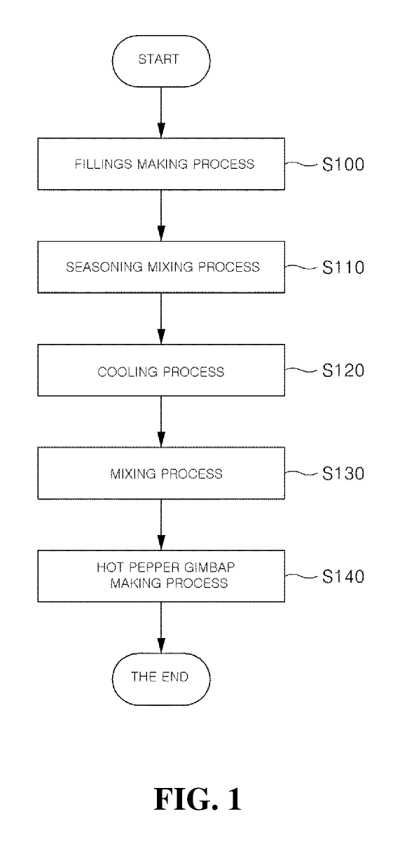

FIG.1 is a process explanation diagram for explaining a method for cooking hot pepper gimbap of the present invention.

Before explaining the present invention, to define terms, hot pepper(Chungyang Chili Pepper) is called as Ttaeong Cho, a dialect used in Gyeongsang province of the Republic of Korea. SHU(Scoville Heat Unit) comes from a name of Wilbur Scoville, an American scientist who first suggested a unit of spicy taste, for comparing spicy intensity.

<<Hot pepper fillings making process-S100>>

First, add a little bit of black pepper and cooking oil to hot pepper fillings, including green Cheongyang chili pepper(green Ttaeong Cho), red Cheongyang chili pepper(red Ttaeong Cho) and carrot, frying until wilted on high heat. Then, hot pepper fillings are made. At this time, the hot pepper fillings have an intensity of 4,000˜10,000 Scoville heat units and it is desirable to use 20˜40 weight percent of green Cheongyang chili pepper with intensity of 4,000˜10,000 Scoville heat units, cut into 1-5mm wide and long, 20˜40 weight percent of red Cheongyang chili pepper, cut into 1-5mm wide and long, and 20˜40 weight percent of carrot, cut into 1˜5 mm wide and long.

<<Seasoning mixing process-S110>>

Further, mix hot pepper fillings and powder seasoning, including condiments and dried powder, together and fry over high heat again until they are thickened. At this time, it is desirable that the powder seasoning comprises 20˜40 parts by weight of condiment, 1˜20 parts by weight of kelp dried powder, 1˜20 parts by weight of spinach dried powder and 1˜20 parts by weight of shiitake mushroom dried powder for 100 parts of weight of hot pepper fillings.

<<Cooling process-S120>>

Next, put hot pepper fillings including powder seasoning in a bowl and cool at room temperature.

<<Mixing process-S130>>

When hot pepper fillings are completed to be cooled, sprinkle black sesame over the rice and mix the cooled hot pepper fillings with it. At this time, it is desirable that the weight of one gimbap roll is 100˜400 g while comprising 60˜90 weight percent of rice and 10˜40 weight percent of hot pepper fillings.

<<Hot pepper gimbap making process-S140>>

Next, make hot pepper gimbap by spreading the mixed rice on the dried seaweed sheet and rolling it. At this time, cut the hot pepper gimbap into certain-size pieces so that a taster can easily try to have it.

Hereinafter, the explanation on the embodiment of the method for cooking hot pepper gimbap according to the present invention is as follows.

First, based on one serving, put green Cheongyang chili pepper(green Ttaeong Cho) 20 g, red Cheongyang chili pepper(red Ttaeong Cho) 20 g and carrot 20 g, which are cut into 3˜4 mm wide and long respectively, in a pan and fry during 5 minutes until wilted on high heat with black pepper 5 g and cooking oil 20 g.

Then, put beef flavored condiment 20 g, kelp dried powder 5 g, spinach dried powder 5 g and shiitake mushroom dried powder 5 g in the pan and fry during 10 minutes over high heat until they are thickened.

Then, place the finished hot pepper fillings in a bowl and cool at room temperature for about 2˜3 hours.

Mix the cooled hot pepper filling with the rice, wherein black sesame 2 g is sprinkled over the rice 250 g and then, they are well mixed with fillings 80 g.

Next, place the dried seaweed sheet, spread the mixed rice over the dried seaweed sheet, and roll it. Then, hot pepper gimbap is finally cooked.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for cooking hot pepper gimbap comprising:
hot pepper fillings making process for adding black pepper and cooking oil to hot pepper fillings, including 20˜40 weight percent of green Cheongyang chili pepper(green Ttaeong Cho), with intensity of 4,000˜10,000 Scoville heat units, cut into 1˜5 mm wide and long, 20˜40 weight percent of red Cheongyang chili pepper (red Ttaeong Cho), with intensity of 4,000˜10,000 Scoville heat units, cut into 1˜5 mm wide and long, and 20˜40 weight percent of carrot, cut into 1˜5 mm wide and long, and frying;
seasoning mixing process for mixing fillings and powder seasoning, including 20˜40 parts by weight of condiment, 1˜20 parts by weight of kelp dried powder, 1˜20 parts by weight of spinach dried powder and 1˜20 parts by weight of shiitake mushroom dried powder for 100 parts of weight of hot pepper fillings, together and frying again;
cooling process for cooling hot pepper fillings with the powder seasoning at room temperature; and
mixing process for sprinkling black sesame over the rice and mixing the cooled hot pepper fillings with it,
wherein weight of one gimbap roll is 100˜400 g while comprising 60˜90 weight percent of rice and 10˜40 weight percent of hot pepper fillings; and hot pepper gimbap making process for spreading the mixed rice on the dried seaweed sheet and rolling it.

2. (canceled)

3. (canceled)

4. (canceled)

5. Hot pepper gimbap cooked by the method for cooking hot pepper gimbap of claim 1.
